(19) United States
(12) Patent Application Publication
(10) Pub. No.: US 2023/0245511 A1
(43) Pub. Date: Aug. 3, 2023

(54) METHOD AND COMPUTING APPARATUS FOR INTEGRATING DYNAMIC WEB SOURCE DATA WITH STANDARD VEHICLE CONFIGURATION DATA FOR A VIN-BASED INQUIRY

(71) Applicant: Mitchell International, Inc., San Diego, CA (US)

(72) Inventors: Scott Baierl, San Diego, CA (US); Srinivasa Vijayareddy, San Diego, CA (US); Julian Louis, San Diego, CA (US); Adan Amaro, San Diego, CA (US); Amit Aggarwal, San Diego, CA (US)

(73) Assignee: Mitchell International, Inc., San Diego, CA (US)

(21) Appl. No.: 17/590,762

(22) Filed: Feb. 1, 2022

(51) Int. Cl. G07C 5/08; G06Q 40/08

(52) U.S. Cl. CPC G07C 5/085; G06Q 40/08

(57) ABSTRACT

A method and computing apparatus for determining comprehensive vehicle information using an intelligent Vehicle Identification Number (“VIN”) decoder process is described. The method and computing apparatus obtains OEM marketing data, OEM engineering data, parts catalog data, uses a machine learning algorithm to determine relational dependencies between the obtained OEM data and standard comprehensive vehicle configuration data to generate complete vehicle data using VIN.

### BACKGROUND

Carriers of insurance for automobile physical damage provide coverage against damage to the insured's vehicle resulting from adverse events such as collision or vandalism. Once a claim is submitted, an insurance adjuster or appraiser evaluates the damage to identify which parts of the vehicle need to be repaired or replaced. This identification of damaged parts is critical for determining the payment insurance company will make to the insured for the damage. For example, the payout may be equal to the estimated cost of repairs when the cost of the vehicle exceeds the cost of repairs. In other words, the goal of the insurance carrier is to estimate the cost associated with repairing or replacing the vehicle parts accurately.

Insurance carriers use various software tools that assist in generating vehicle information used to prepare an appraisal. For example, when identifying cost of damaged parts software may use known vehicle information, such as make, model, and optional modifications (e.g., sub-model and trim level). That is, the software may identify all the standard parts by relying on data that stores associations between standard options (parts) and a vehicle of a particular make and model. To expedite this process, solutions exist that “decode” Vehicle Identification Number (“VIN”) to obtain the associated vehicle information, including the standard options.

Additionally, a proprietary manufacturer data store may be accessed to retrieve additional or optional vehicle information using VIN. Accurate vehicle information is essential when obtaining accurate repair cost during vehicle appraisal. Because vehicle information encoded in the VIN (i.e., vehicle information that is obtained by using standard data mappings) will is incomplete and, the insurance appraisal that utilizes this method may not always be accurate. Methods that can use VIN to access proprietary manufacturer databases resulting in more granular information about the vehicle are needed.

### SUMMARY

In accordance with one or more embodiments, various features and functionality are provided to enable a VIN decoder to obtain complete vehicle information.

In some embodiments, a method may apply a machine learning algorithm to determine relational dependencies between a vehicle configuration data sets associated with vehicles in existing and new vehicle collision claims and engineering data sets and build sheet data sets based on: current vehicle configuration data comprising a plurality of possible parts included in a vehicle, current engineering data comprising a plurality of actual parts included in the vehicle, and/or current build sheet data comprising a one or more of bundles of individual parts included in the vehicle, wherein each individual part includes a price. In some embodiments, the method may transmit the relational dependency between each of the possible parts identified by the vehicle configuration data sets, the engineering data set, and the build sheet data sets to one or more datastores.

In some embodiments, the method may train the machine learning algorithm based on at least historic vehicle configuration data comprising a plurality of possible parts in vehicles associated with prior vehicle collision claims, historic engineering data comprising a plurality of actual parts in vehicles associated with prior vehicle collision claims, and historic build sheet data comprising a one or more of bundles of individual parts in vehicles associated with prior vehicle collision claims, wherein each individual part includes a price.

In some embodiments, the method may generate complete vehicle information data sets associated with associated with the vehicles in the existing and the new vehicle collision claims based on the relational dependencies between the vehicle configuration data sets, the engineering data sets, and the build sheet data sets.

In some embodiments, the complete vehicle information data sets may identify actual parts in the engineering and build sheet data sets corresponding to the possible parts in the vehicle configuration data sets.

In some embodiments, the method may determine a type of loss (e.g., partial or total) associated with the existing and new vehicle collision claims based on the complete vehicle information data sets. In some embodiments, the complete vehicle information data sets may be used to generate estimates for repairing damage associated with the existing and new vehicle collision claims. In some embodiments, the current and historic vehicle configuration data sets may be associated with one of a plurality of vehicle manufacturers.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example intelligent VIN system, according to an implementation of the disclosure.

FIG. 2 illustrates an example standard configuration data, according to an implementation of the disclosure.

FIG. 3 illustrates an example intelligent VIN process, according to an implementation of the disclosure.

FIG. 4 illustrates an example mapping process, according to an implementation of the disclosure.

FIG. 5 an example diagram of obtaining standard vehicle configuration and OEM data to determine relational dependencies between OEM data and standard vehicle configuration data for a total-loss claim, according to an implementation of the disclosure.

FIG. 6A illustrates an example diagram of obtaining standard vehicle configuration data for a partial-loss claim, according to an implementation of the disclosure.

FIG. 6B illustrates an example diagram of obtaining OEM data to determine relational dependencies between OEM data and standard vehicle configuration data for a partial- loss claim, according to an implementation of the disclosure.

FIG. 7 illustrates an example diagram of obtaining NAGS identification data, according to an implementation of the disclosure.

FIG. 8 illustrates an example diagram of using recall data, according to an implementation of the disclosure.

FIG. 9 illustrates an example computing system that may be used in implementing various features of embodiments of the disclosed technology.

Described herein are systems and methods for improving the standard VIN process. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

As alluded to above, decoding 11 digits of the 17-digit VIN is a fast and proven way to obtain vehicle information used in the damage appraisal process. Vehicle information obtained via the standard VIN decoder process is limited to data from nine standard categories including country, year, make, model, sub-model (trim), body, engine, transmission, and drive. However, vehicle configuration data obtained by decoding the VIN does not always provide actual part information. For example, the simple VIN decoder process will recognize that a vehicle includes a windshield but will fail identify the exact type of windshield (e.g., there can be seventeen different windshield options for a given vehicle). Furthermore, collision repair process increasingly involves optional equipment and complex electronics that are only specified in the data provided by the original manufacturer (OEM). Identifying optional equipment is critical for an accurate appraisal. Unfortunately, VIN decoder fails to identify any optional equipment, thereby forcing the estimator conducting the valuation to often make an arbitrary selection of a. Whether the estimate is for a partial-loss or a total-loss valuation of the vehicle, determining exact parts on the vehicle is essential for both performing a safe and proper repair (in the partial- loss scenario) and obtaining accurate estimate (in the total-loss scenario). For example, to accurately perform a total-loss valuation (i.e., a scenario in which the cost of repairs exceeds the cost of the vehicle) using the VIN decoder, the information decoded from the VIN must include the exact parts (i.e., the options) associated with a particular vehicle along with the manufacture suggested retail price (MSRP) so that the value of the vehicle can be adjusted using the parts actually installed.

Currently, detailed part-level information specifying what is actually installed on a particular vehicle (e.g., axle ratio, wheel type and size, build date, build plant, etc.) is provided by manufacturer engineering data. This data comes from the engineering department and assembly line of the manufacturer. “Carmakers” or “makers” or “OEMs” are the automotive manufacturers (e.g., Chevrolet, Ford, or Honda). “Models” are names used by the makers to market a range of similar cars the types the (e.g., Chevrolet Malibu, Ford Focus, or Honda Accord). Some carmakers, including Acura, BMW and Lexus, use alphanumeric model names, e.g., MDX, 328i, or ES 350.

The model often defines the platform (which determines the engines, drivetrains and chassis options available), body styles and aesthetic theme; while equipment, upholstery and exterior trim are usually determined by the “trim” or “trim level.” Some models have only one body style (e.g., the Hyundai i20 hatchback), while other models are produced in several body styles (e.g., the Audi A3, which has been produced in hatchback, sedan and convertible body styles).

Often the same manufacturer will use variations of the same part used on the same “model”. Thus, the same model may be distinguished based on the “trim” (i.e., based on a particular set of equipment or special features). For a given car model, the trim level denotes which equipment and features are included as standard. A car buyer may add to this standard equipment with trim packages or individual options. The trim level with the least equipment/features is referred to as the entry-level or “base model” and the trim level with the most equipment/features is referred to as “highest specification”. Differences between trim levels typically consist of interior equipment (e.g., leather seats and reversing cameras) and cosmetic changes, however, sometimes a trim level can include mechanical changes such as different engines, suspension, or all-wheel drive systems. Accordingly, different trim levels or trim lines for the same model may include variations of the same part. By contrast, options are features that do not come as standard equipment with the vehicle. These items can range from a sunroof to an upgraded stereo and even a larger engine.

Notably, engineering data does not indicate the price, i.e., the manufacturer suggested retail price (“MSRP”) for each part. Instead, the marketing department is tasked with providing the pricing data. This pricing data is customarily included in the build sheet or the window sticker (i.e., the label displayed in all new automobiles that includes the listing of certain official information about the car).

Manufacturers often combine certain parts into one or more packages that are priced as a bundle. For example, parking assistant, a 360-degree camera with split view and front washer, a cargo area cover, a hands-free, foot activated liftgate may be included in a technology or comfort package marketed to consumers at a particular price. Thus, the build sheet contains options and packages along with their MSRPs as defined by the marketing department of the OEM.

Most OEMs publish an electronic parts catalog, which is a catalog representation of the engineering data for the vehicle, including part numbers and other relevant data for their products or parts thereof. However, not every manufacturer provides both the engineering data (i.e., part-level information specifying what is actually installed on a particular vehicle) and the build data (i.e., MSRP for each part and options and packages along with their MSRPs). Further still, some OEMs fail to provide an electronic parts catalog altogether. Inconsistencies between OEM in providing electronic parts catalogs significantly affects the accuracy of the appraisal using the simple VIN decoder. The present embodiments relate provide detailed information about the vehicle (i.e., parts, options, features, packages, and associated MSRPs) using the data decoded from the VIN.

In accordance with various embodiments, a system and method for providing a system for identifying specific vehicle information, including determining relational dependencies between OEM parts obtained from OEM build sheets, engineering data, OEM parts catalogs, and standard comprehensive vehicle configuration data is disclosed.

The standard comprehensive vehicle configuration data may represent all possible vehicle configurational elements that may or may not be present in an actual vehicle. That is, this data is not actually representative of what is included in a particular vehicle. Rather it represents all possible options and parts that could be included. The configuration data, for example, may be stored in a database such as a Vehicle Configuration Database (VCD) and include fields representing configuration elements of vehicle for a particular year/make/model/body style. These configuration elements may include VIN data and industry standard data from systems such as ACES, Chrome Data, JDPA, Balckbook, Redbook and so on. In other words, the VCD may include a “skeleton” of all possible options a vehicle may have. By identifying which OEM build and engineering data elements correspond to which fields within the VCD results in a standardized representation of a vehicle. As alluded to above, using a standardized VCD during the appraisal process results in a more accurate valuation.

At least some of the example embodiments include, but are not limited to include, one or more of the following features: (i) establishing a connection with an OEM's web service via an application programming interface (API) of the OEM of a particular vehicle identified in the VIN, (ii) receiving OEM engineering data (i.e., parts information) and OEM build data (e.g., MSRPs for each part identified in the OEM engineering data and options and packages along with their MSRPs), (iii) applying a machine learning technique to identify relational dependencies between the obtained OEM build, engineering, and parts catalog data, and existing standard comprehensive vehicle configuration data (iv) recording the identified relational dependencies or mappings, (v) generating complete vehicle information (i.e., accurate list of all of parts and MSRP) from the standard comprehensive vehicle configuration data mapped to the OEM engineering and the OEM build data, and (v) accessing the complete vehicle information during the appraisal process.

Identifying relational dependencies between OEM parts obtained from OEM build sheets, engineering data, parts catalogs, and standard comprehensive vehicle configuration data may require input from an expert user, and thus is time consuming and costly. Furthermore, some OEM's do not provide both the build sheet and the engineering data making the process described above ineffective.

The present embodiments resolve the problem of mapping OEM data by applying a number of techniques, including machine learning. For example, machining learning process trained on previously identified relational dependencies between OEM parts obtained from OEM build sheets, engineering data, parts catalogs, and standard comprehensive vehicle configuration data may determine dependencies for any obtained OEM data.

Similarly, the problem of incomplete OEM data may be solved by using machine learning algorithm, as described above. Accordingly, for those OEMs that provide incomplete data, the process is configured to determine the missing OEM engineering data (or missing OEM build data) by utilizing machine learning trained to recognize what OEM data is missing. The machine learning algorithm may be trained using data that was previously compiled by data analysts (experts) to create a complete mapping for a vehicle.

Further still, while OEM data (build data and engineering data) is far superior to generic vehicle information encoded in VIN, OEM data does not include repair information associated with replacing or repairing a particular part. In one embodiment, the method is configured to automate the acquisition and mapping of OEM parts associated with OEM build sheets and services equipment codes.

In some embodiments, the system and method may be configured to provide a graphical user interface that allows users to view and modify the relational dependencies between OEM parts obtained from OEM build sheets, engineering data, parts catalogs, and standard comprehensive vehicle configuration data. The modifications in turn may be fed to the machine learning algorithm thereby increasing its reliability rate.

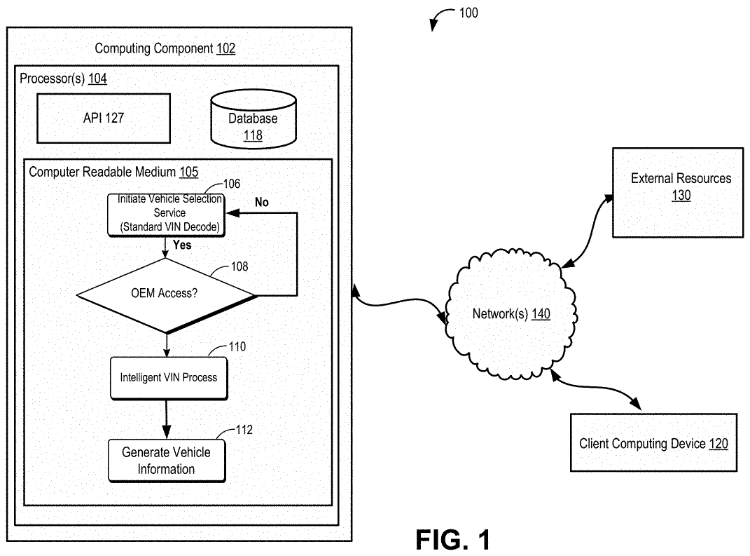

FIG. 1 illustrates an intelligent VIN system 100, in accordance with the embodiments disclosed herein. This diagram illustrates an example system 100 that may include a computing component 102 in communication with a network 140. The system 100 may also include one or more external resources 130 and a client computing device 120 that are in communication with network 140. External resources 130 may be located in a different physical or geographical location from the computing component 102.

As illustrated in FIG. 1, computing component or device 102 may be, for example, a server computer, a controller, or any other similar computing component capable of processing data. In the example implementation of FIG. 1, computing component 102 includes a hardware processor 104 configured to execute one or more instructions residing in a machine-readable storage medium 105 comprising one or more computer program components.

Hardware processor 104 may be one or more central processing units (CPUs), semiconductor-based microprocessors, and/or other hardware devices suitable for retrieval and execution of instructions stored in computer readable medium 105. Processor 104 may fetch, decode, and execute instructions 106-112, to control processes or operations for determining extended vehicle information using VIN. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

A computer readable storage medium, such as machine-readable storage medium 105 may be any electronic, magnetic, optical, or other physical storage device that contains or stores executable instructions. Thus, computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 106-112.

As noted above, hardware processor 104 may control processes/operations for generating complete vehicle information (i.e., actual prats and their MSRP installed) by executing instructions 106-112. Hardware processor 104 may execute instruction 106 to perform the standard VIN decode. The standard VIN decode may obtain vehicle information limited to country, year, make, model, sub-model (trim), body, engine, transmission, and drive. Next, hardware processor 104 may execute instruction 108 to determine whether access to OEM exists. For example, an HTTP 401 error, e.g., “access denied” could be returned from the OEM web service in the event no access exists.

Upon determining that access to OEM web service via API 127 has been established, hardware processor 104 may execute instruction 110 to perform the intelligent VIN process. The intelligent VIN process may begin by obtaining OEM data and then mapping it onto the standard comprehensive vehicle configuration data structure. The intelligent VIN process may apply a plurality of Al functions to perform mapping. The Al functions may be implemented in any manner. For example, one or more of the Al functions may be implemented as trained machine learning models. The machine learning models may include computer vision machine learning models, natural language processing machine learning models, and the like.

The system 100 may include one or more databases 118, which may store vehicle configuration data, OEM engineering data, OEM build sheet data, vehicle repair procedures, completed estimates, estimates in process, data regarding parts, part costs, labor, labor costs, and the like. In some embodiments, the databases 118 may include one or more standard natural language algorithmic techniques, such as stemming/lemmatization/stop words/HTML Tags removal/common words, which can be achieved using a myriad of Natural Language Processing (NLP) tools (e.g., Beautiful Soup, NLTK, GENSIM, etc.) The natural language processing databases may include rules, documents, and the like for use with the standard natural language processing machine learning models.

In some embodiments, the machine learning model may be trained with vehicle configuration and OEM (engineering and build sheet data) content. The vehicle configuration and OEM content may include vehicle specifications, vehicle repair procedures, OEM engineering data, OEM build sheet data, parts catalogs, and the like. The machine learning model may ingest and process the vehicle configuration and OEM content to generate machine learning rules and processed NLP content databases. The machine learning model may further curate the ingested vehicle repair content through other artificial intelligence technologies including image analysis, text mining, deep analysis, and the like.

In some embodiments, the standard VIN decode may be triggered upon entering details related to a loss event associated with a vehicle within the system 100. For example, information related to a new loss event (e.g., partial-loss or total-loss) may be entered via a graphical user interface of a client application running on the client computing device 120 and communicating with computing component 102 via network 140.

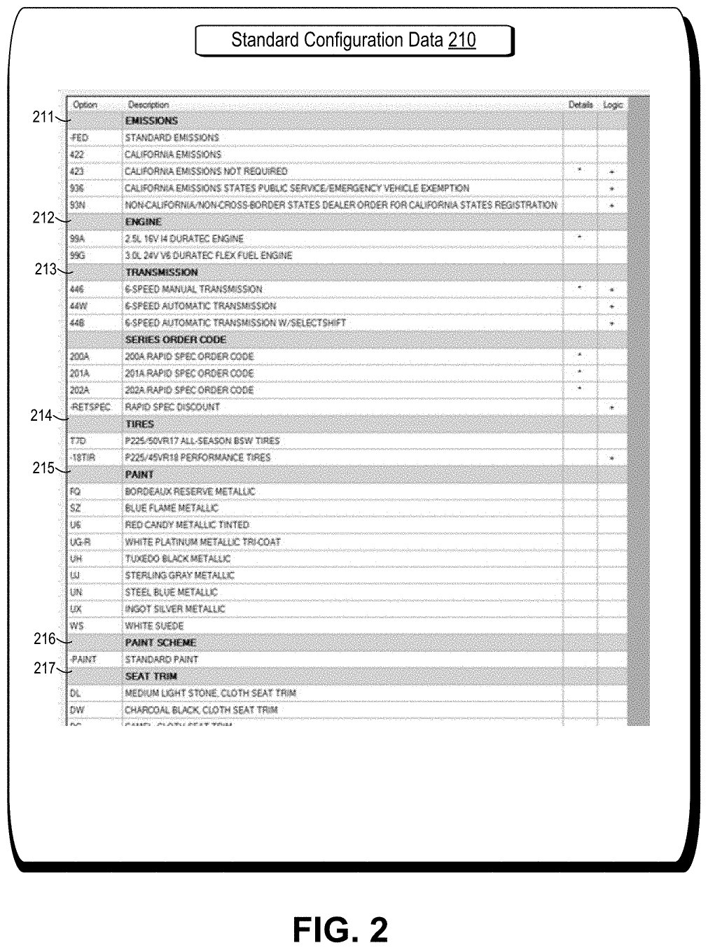

As explained above, intelligent VIN system is configured to determine what OEM data element (either from the marketing or engineering data set or from the parts catalog) corresponds to a data element of a standard comprehensive vehicle configuration data stored in a database 118. For example, database 118 may be a Vehicle Configuration Database (VCD). As illustrated in FIG. 2, vehicle configuration data 210 may include vehicle configuration categories 211-216, each representing a set of options for that configuration category. Some but not all options may be present in a given vehicle.

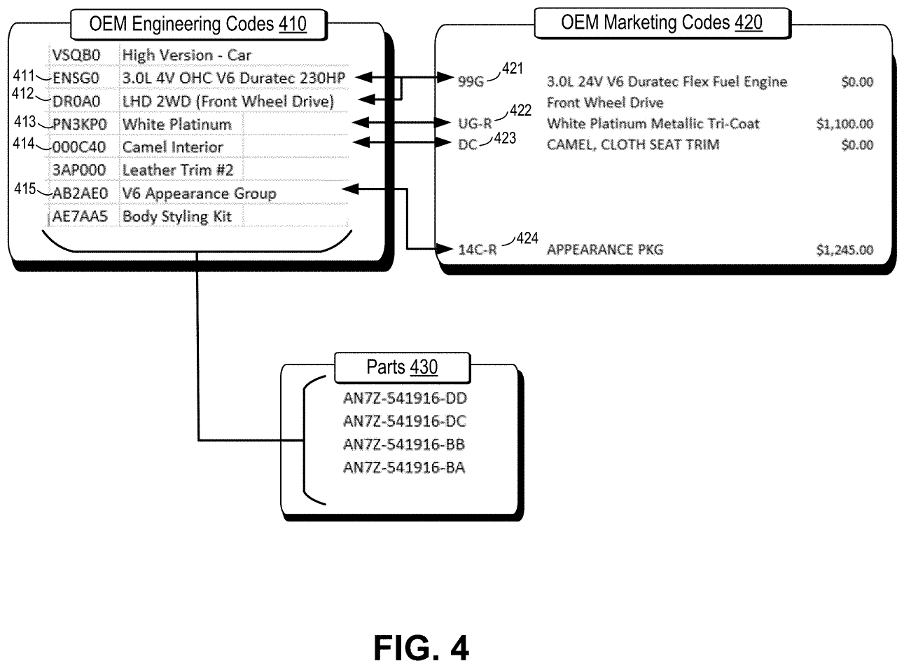

Referring back to FIG. 1, instruction 110 executed by hardware processor 104 may perform the intelligent VIN process. The intelligent VIN process may begin by obtaining the OEM data. Next, the data extracted from the obtained OEM data may be mapped to the standard comprehensive vehicle configuration data structure, e.g., as illustrated in FIG. 4. The intelligent VIN process may utilize a machine learning algorithm to perform the mapping.

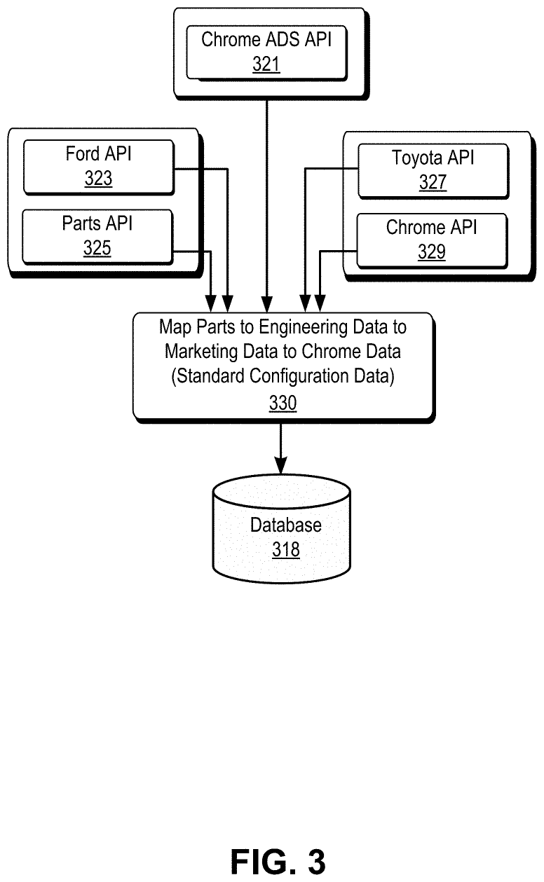

An example intelligent VIN process is illustrated in FIG. 3. In this example, standard comprehensive vehicle configuration data may be obtained via Chrome w/o Build Data API in 321. At this time, a query using VIN number against vehicle configuration database is made. If the VIN does not have high enough resolution to allow us to determine all eight data elements, e.g., Body, Year, Make, Model, Sub-model, Engine, Drive and Transmission, the Chrome API process is called to determine if a more complete match can be made. Chrome w/o Build Data API is called through automation by providing a VIN and the API will return key data elements for that specific VIN. By utilizing Chrome w/o Build Data API, the standard VIN decoder can identify all eight data elements automatically about 62% of the time to over 80% of the time. Adoption of API's like Chrome w/o Build Data API will provide an early insight into vehicle configuration as they are being built by various OEMs not yet released to consumer market.

Next, OEM engineering data may be obtained from an OEM web services via OEM API, in this case Ford API 323. Similarly, parts catalog data may be obtained from OEM web services via API 325. As explained earlier, the electronic parts catalog or (“EPC”) is an electronic catalog of vehicle parts powered by the engineering data and is usually a web application that allows the user to browse through all of an OEM's vehicles and lookup the parts that would be on the vehicle. Often, the web application is used by car dealership when selling replacement parts to consumers and various others.

However, in the intelligent VIN process, the EPC is used in determining collision estimating data. Thus, for the purposes of intelligent VIN, the engineering data behind the EPC is accessed by the API that returns the engineering data for a specific vehicle at a time.

Finally, marketing data (i.e., build sheets) may be obtained from OEM web services via OEM API, in this case Toyota API 327. Finally, data is obtained via Chrome with Build Data API 329.

Once all the data is obtained, the intelligent VIN process identifies relational dependencies between OEM part numbers obtained from OEM build sheets, engineering data, parts catalogs, and standard comprehensive vehicle configuration data in 330. For example, as described in FIG. 4, OEM marketing codes in 420 may be mapped to OEM engineering codes 410, which in turn may be mapped to product codes 430. More specifically, marketing code 421 may be mapped to engineering codes 411 and 412. Further, marketing code 422 may be mapped to engineering code 413, marketing code 423 may be mapped to engineering code 414, and marketing code 424 may be mapped to engineering code 415. Further, engineering codes 410 may be associated with product codes 430 and stored in a database. For example, and referring back to FIG. 3, the data mappings may be stored in database 318.

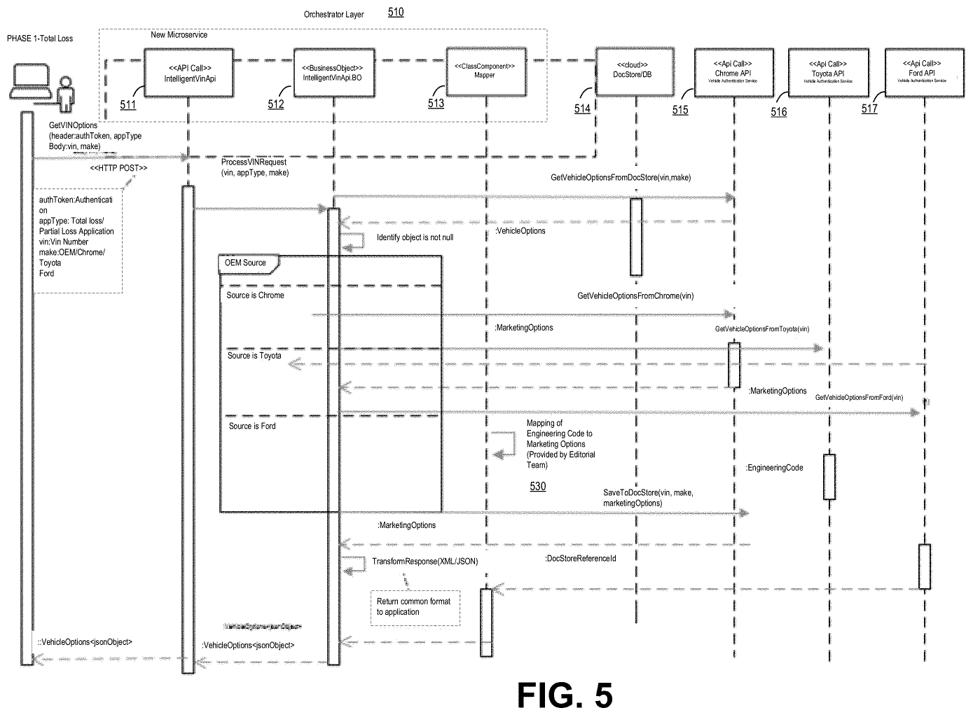

FIG. 5 illustrates an example process for obtaining standard vehicle configuration and OEM data to determine relational dependencies between OEM data and standard vehicle configuration data for a total-loss claim. Partial-loss characterizes a scenario in which the vehicle damaged in a collision incident is to be repaired based on the collision repair estimate (i.e., the damage to the vehicle does not exceed a substantial portion of the value of the vehicle). The process includes running a number of microservices. For example, the orchestrator layer 510 includes IntelligentVinAPI (API call) 511, IntelligentVinAPI.BO 512 (business object), and mapper (class component) 513 microservices. The remaining microservices outside of the orchestrator layer 510 include docstore/DB (Cloud) 514, ChromeAPI (API call) for vehicle authentication service 515, and one or more OEM API calls, e.g., Toyota API call 516 and Ford API call 517. Once the process obtains OEM source data at 520, the process maps the data by identifying relational dependencies between OEM data and standard vehicle configuration data. The mapping process may apply implemented by the intelligent VIN process may apply a plurality of Al functions to perform mapping, as alluded to above. In some embodiments, the one or more of the Al functions may include one or more trained Al functions. For example, an Al function may be implemented as a trained mapping machine learning model. The machine learning model may be trained, for example, with historic mapping data (e.g., data that has been manually mapped by expert users).

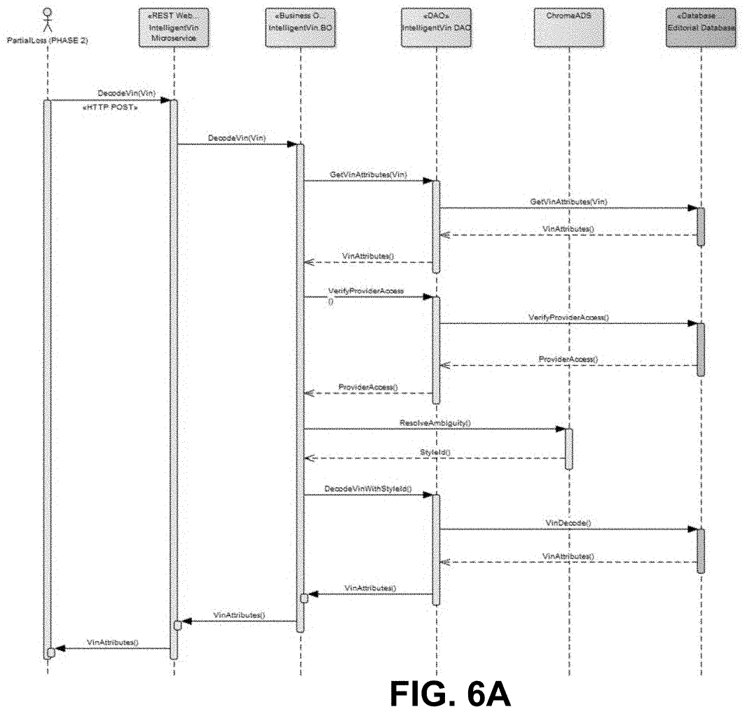

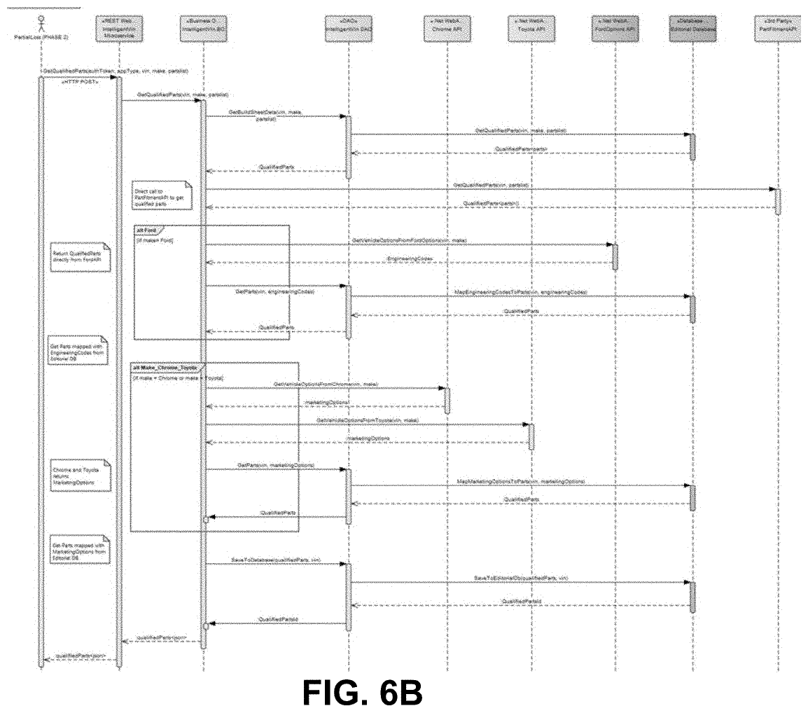

Similarly, FIGS. 6A-6B illustrate an example process for obtaining standard vehicle configuration and OEM data to determine relational dependencies between OEM data and standard vehicle configuration data for a partial-loss claim.

In particular, FIG. 6A illustrates exemplary microservices and commands for obtaining standard vehicle configuration data, while FIG. 6B illustrates microservices and commands for obtaining OEM data to determine relational dependencies between OEM data and standard vehicle configuration data (obtained in FIG. 6A). This process utilizes a machine learning algorithm trained on historic mapping data (e.g., data that has been manually mapped by expert users).

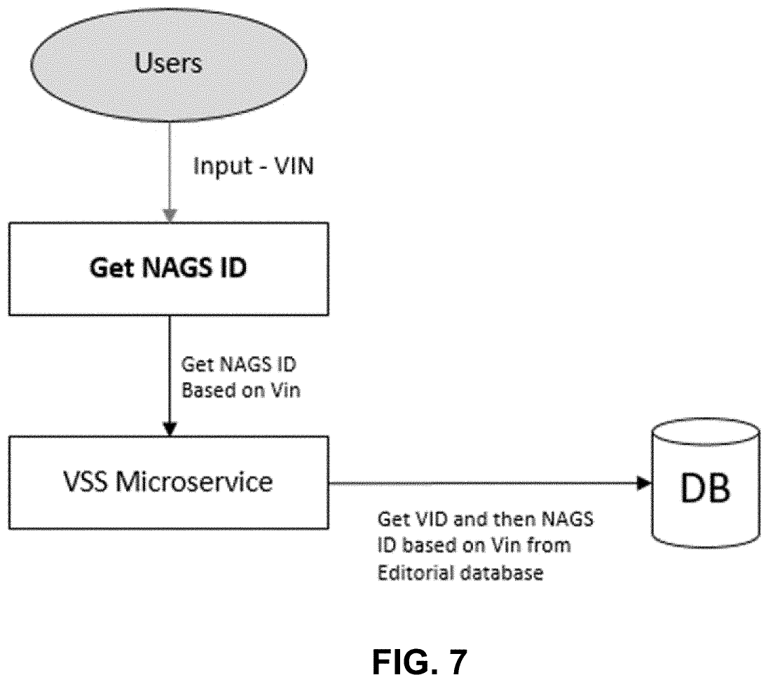

Additionally, as illustrated in FIG. 7, the process illustrated in FIGS. 5 AND 6A-6B may use additional microservices to identify parts catalog data using a National Auto Glass Specifications (NAGS) identification accessed via the VSS microsystem process. The data points obtained from NAGS may be used to repair glass related parts in a particular vehicle that requires VIN.

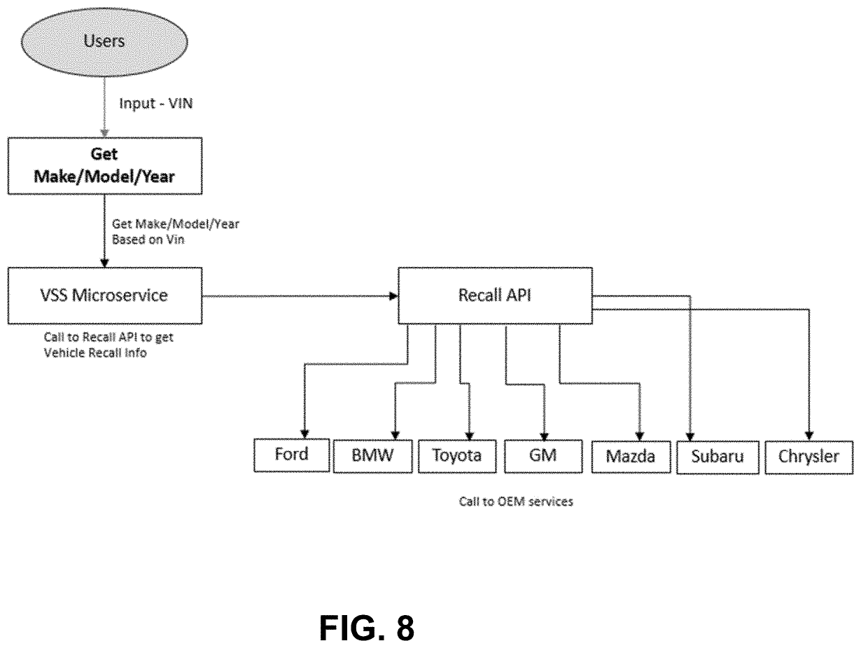

Further, as illustrated in FIG. 8, the process illustrated in FIGS. 5 AND 6A-6B may use additional microservices implemented in conjunction with a recall process. The recall process provides data regarding parts/services that vehicle manufacturers have deemed as “recalled” and should be addressed appropriately for that specific VIN. Recall data is provided directly from vehicle manufacturers.

Referring back to FIG. 1, hardware processor 104 may execute instruction 112 to generate complete vehicle information upon completing the mapping of the OEM data and standard vehicle configuration data, as described above.

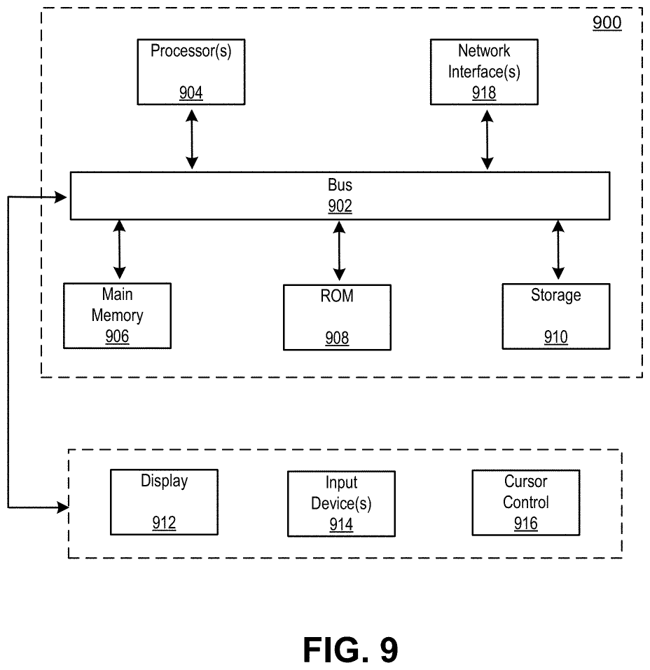

In some embodiments, the complete vehicle information may be accessed during the appraisal process. In particular, the estimate detailing the loss may be generated using the actual parts and their MSRP. In the case of the partial-loss, the MSRP of the damaged parts will be used to determine the value of the reimbursement. Unlike partial-loss, total-loss, characterizes a scenario in which the damage to the vehicle exceeds a substantial portion of the value of the vehicle, thus it requires a determination of the total value of the vehicle for the replacement. Accordingly, in the total-loss scenario, the MSRP of all the parts will be used to determine the total value of the vehicle for the replacement.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 9. Various embodiments are described in terms of this example computing module 900. After reading this description, it will become apparent to a person skilled in the relevant art how to implement the technology using other logical circuits or architectures.

FIG. 9 illustrates an example computing module 900, an example of which may be a processor/controller resident on a mobile device, or a processor/controller used to operate a computing device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 9. Various embodiments are described in terms of this example-computing module 900. After reading this description, it will become apparent to a person skilled in the relevant art how to implement the application using other computing modules or architectures.

Referring now to FIG. 9, computing module 900 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 900 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 900 might include, for example, one or more processors, controllers, control modules, or other processing devices, such as a processor 904. Processor 904 might be implemented using a general-purpose or special-purpose processing engine such as, for example, a microprocessor, controller, or other control logic. In the illustrated example, processor 904 is connected to a bus 902, although any communication medium can be used to facilitate interaction with other components of computing module 900 or to communicate externally. The bus 902 may also be connected to other components such as a display 912, input devices 914, or cursor control 916 to help facilitate interaction and communications between the processor and/or other components of the computing module 900.

Computing module 900 might also include one or more memory modules, simply referred to herein as main memory 906. For example, preferably random-access memory (RAM) or other dynamic memory might be used for storing information and instructions to be executed by processor 904. Main memory 906 might also be used for storing temporary variables or other intermediate information during execution of instructions to be executed by processor 904. Computing module 900 might likewise include a read only memory (“ROM”) 908 or other static storage device 910 coupled to bus 902 for storing static information and instructions for processor 904.

Computing module 900 might also include one or more various forms of information storage devices 910, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 910 might include other similar instrumentalities for allowing computer programs or other instructions or data to be loaded into computing module 900. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 900.

Computing module 900 might also include a communications interface or network interface(s) 918. Communications or network interface(s) interface 918 might be used to allow software and data to be transferred between computing module 900 and external devices. Examples of communications interface or network interface(s) 918 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 918 might typically be carried on signals, which can be electronic, electromagnetic (which includes optical) or other signals capable of being exchanged by a given communications interface. These signals might be provided to communications interface 918 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 906, ROM 908, and storage unit interface 910. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 900 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for determining vehicle information, the method comprising:
executing, by a computing device, a machine learning algorithm that determines relational dependencies between vehicle configuration data sets associated with vehicles, engineering data sets associated with the vehicles, and build sheet data sets associated with the vehicles based on:
current vehicle configuration data representing a plurality of possible parts included in the vehicles,
current engineering data representing a plurality of actual parts included in the vehicles, and
current build sheet data representing one or more of bundles of individual parts included in the vehicles, wherein the build sheet data includes prices for the individual parts;
transmitting, by the computing device, the relational dependencies to one or more datastores;
receiving as input, by the computing device, a vehicle identification number (VIN) for a given vehicle; and
generating, by the computing device, an estimate for repair of the given vehicle based on the relational dependencies by accessing the one or more datastores using the VIN.

2. (canceled) The method of claim 1, further comprising training, by the computing device, the machine learning algorithm based on at least:
historic vehicle configuration data comprising a plurality of possible parts in vehicles associated with prior vehicle collision claims;
historic engineering data comprising a plurality of actual parts in vehicles associated with prior vehicle collision claims; and
historic build sheet data comprising a one or more of bundles of individual parts in vehicles associated with prior vehicle collision claims, wherein each individual part includes a price.

3. The method of claim 2, further comprising generating, by the computing device, complete vehicle information data sets associated with vehicles in existing and new vehicle collision claims based on the relational dependencies between the vehicle configuration data sets, the engineering data sets, and the build sheet data sets.

4. The method of claim 3, wherein the complete vehicle information data sets identify actual parts in the engineering and build sheet data sets corresponding to the possible parts in the vehicle configuration data sets.

5. The method of claim 3, further comprising determining a type of loss associated with the existing and new vehicle collision claims based on the complete vehicle information data sets.

6. The method of claim 5, wherein the complete vehicle information data sets are used to generate estimates for repairing damage associated with the existing and new vehicle collision claims.

7. The method of claim 2, wherein the current and historic vehicle configuration data sets are associated with one of a plurality of vehicle manufacturers.

8. A computing apparatus for determining vehicle information, comprising:
a processor; and
a memory coupled to the processor; wherein the processor is configured to:
execute a machine learning algorithm that determines relational dependencies between vehicle configuration data sets associated with vehicles, engineering data sets associated with vehicles, and build sheet data sets associated with vehicles based on:
current vehicle configuration data representing a plurality of possible parts included in the vehicles,
current engineering data representing a plurality of actual parts included in the vehicles, and
current build sheet data representing one or more of bundles of individual parts included in the vehicles, wherein the build sheet data includes prices for the individual parts;
transmit the relational dependencies to one or more datastores;
receiving as input a vehicle identification number (VIN) for a given vehicle; and
generating an estimate for repair of the given vehicle based on the relational dependencies by accessing the one or more datastores using the VIN.

9. The computing apparatus of claim 8, wherein the processor is further configured to train the machine learning algorithm based on at least:
historic vehicle configuration data comprising a plurality of possible parts in vehicles associated with prior vehicle collision claims;
historic engineering data comprising a plurality of actual parts in vehicles associated with prior vehicle collision claims; and
historic build sheet data comprising a one or more of bundles of individual parts in vehicles associated with prior vehicle collision claims, wherein each individual part includes a price.

10. The computing apparatus of claim 9, wherein the processor is further configured to generate complete vehicle information data sets associated with vehicles in existing and new vehicle collision claims based on the relational dependencies between the vehicle configuration data sets, the engineering data sets, and the build sheet data sets.

11. The computing apparatus of claim 10, wherein the complete vehicle information data sets identify actual parts in the engineering and build sheet data sets corresponding to the possible parts in the vehicle configuration data sets.

12. The computing apparatus of claim 10, wherein the processor is further configured to determine a type of loss associated with the existing and new vehicle collision claims based on the complete vehicle information data sets.

13. The computing apparatus of claim 11, wherein the complete vehicle information data sets are used to generate estimates for repairing damage associated with the existing and new vehicle collision claims.

14. The computing apparatus of claim 9, wherein the current and historic vehicle configuration data sets are associated with one of a plurality of vehicle manufacturers.

15. A non-transitory computer-readable storage medium storing a plurality of instructions executable by one or more processors, the plurality of instructions when executed by the one or more processors cause the one or more processors to:
execute a machine learning algorithm that determines relational dependencies between vehicle configuration data sets associated with vehicles, engineering data sets associated with vehicles, and build sheet data sets associated with vehicles based on:
current vehicle configuration data representing a plurality of possible parts included in the vehicles,
current engineering data representing a plurality of actual parts included in the vehicles, and
current build sheet data representing one or more of bundles of individual parts included in the vehicles, wherein the build sheet data includes prices for the individual parts;
transmit, the relational dependencies to one or more datastores;
receiving as input a vehicle identification number (VIN) for a given vehicle; and
generating an estimate for repair of the given vehicle based on the relational dependencies by accessing the one or more datastores using the VIN.

16. The method of claim 15, further comprising training, by the computing device, the machine learning algorithm based on at least:
historic vehicle configuration data comprising a plurality of possible parts in vehicles associated with prior vehicle collision claims;
historic engineering data comprising a plurality of actual parts in vehicles associated with prior vehicle collision claims; and
historic build sheet data comprising a one or more of bundles of individual parts in vehicles associated with prior vehicle collision claims, wherein each individual part includes a price.

17. The non-transitory computer-readable storage medium of claim 16, further comprising generating, by the computing device, complete vehicle information data sets associated with vehicles in existing and new vehicle collision claims based on the relational dependencies between the vehicle configuration data sets, the engineering data sets, and the build sheet data sets.

18. The non-transitory computer-readable storage medium of claim 17, wherein the complete vehicle information data sets identify actual parts in the engineering and build sheet data sets corresponding to the possible parts in the vehicle configuration data sets.

19. The non-transitory computer-readable storage medium of claim 17, further comprising determining a type of loss associated with the existing and new vehicle collision claims based on the complete vehicle information data sets.

20. The non-transitory computer-readable storage medium of claim 19, wherein the complete vehicle information data sets are used to generate estimates for repairing damage associated with the existing and new vehicle collision claims.

21. The non-transitory computer-readable storage medium of claim 16, wherein the current and historic vehicle configuration data sets are associated with one of a plurality of vehicle manufacturers.
